(19) United States
(12) Patent Application Publication
(10) Pub. No.: US 2010/0273698 A1
(43) Pub. Date: Oct. 28, 2010

(54) Compositions

(75) Inventors: Gunnar Noding, Ludwigshafen (DE); Frederic Moreux, Granollers (ES)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/670,948

(22) PCT Filed: Jul. 30, 2008
(86) PCT No.: PCT/GB2008/002597

§ 371 Date: Jun. 30, 2010

(30) Foreign Application Priority Data
Jul. 31, 2007 (GB) 0714811.7

(51) Int. Cl. C11D 17/00; B65B 51/16; B65B 51/10

(52) U.S. Cl. 510/224; 510/298; 53/436; 53/463

(57) ABSTRACT

A process for the preparation of a package containing a compacted particulate composition, comprises wrapping a compacted particulate composition to sealing same with at least one film. Thereafter treating the resultant seams of the sealed composition to produce a package that is suitable for handling by a user than known packages.

### FIELD OF THE INVENTION

The present invention relates to a process for the preparation of a package containing a compacted particulate composition, preferably a water-soluble package.

### BACKGROUND

Tablets of a compressed particulate composition for use in dishwashing machines or laundry washing machines are well known. Such tablets are added to the machine at the start of its operation and are fully consumed by the end of the operation. Examples of such tablets are dishwashing tablets such as those sold under the trade mark Finish, water-softening tablets such as those sold under the trade mark Calgon, and laundry detergent tablets such as those sold under the trade mark Persil.

Such tablets are fairly fragile, and liable to break, fracture or chip, particularly when dropped onto the floor by a consumer, or when a package containing them falls from a high shelf when being stored in, for example, a warehouse or supermarket. It is possible to improve the strength of tablets by increasing the pressure at which they are compressed, but this can undesirably retard their dissolution when they are used.

There is almost always a complex interplay of factors in developing products of this type. There is often a compromise between the hardness of a tablet, and thus its durability, its friability, how easily it will chip or flake, and the dissolution time. In producing compacted particulate compositions the choice of ingredients can also be constrained; the use of too much organic material often leads to a slow solubilising product and large amounts of crystalline ingredients may need a binder added. In any event at least one disintegrating agent is usually needed, such as hydrated water-soluble salts (for example sodium acetate trihydrate), swelling agents (for example amorphous cellulose) or wicking agents (for example microcrystalline cellulose) to draw water into the solid. The use of disintegrating/binding agents, or any tabletting aid, adds to the cost of the tablet.

Most tablets are wrapped in a material prior to packaging, such as blister packs, or foil wrapped into individual sachets. Often the wrapping is needed for any one or more of the following reasons: (1) to act as a physical barrier, so as to protect the contents from moisture; (2) to physically protect the contents such that if they fracture, the broken tablet does not contaminate the primary packaging; (3) to act as a child resistant closure.

Packaging of food fragile articles with flexible wrapping material is disclosed in GB 1 487 922. Packaging of tablets is known in the art. For example, U.S. Pat. No. 4,133,431 discloses a stack of brittle tablets shrink wrapped with rigid separator and indicator elements between each tablet group and at the ends of the stack. U.S. Pat. No. 4,928,813 discloses a capsule comprising a tablet section having at least one chlorine compound tablet and a shell securely fitted around the tablet section. The shell has two apertures at opposite ends, each extension extending away from the tablet section and having a conduit communicating with an aperture to reduce the dissolution rate of the chlorine into the water.

DE 10025187 discloses tablets that are packed in foil bags set in an outer packaging formed by a non-self supporting wrapping. The wrapping can be made of paper or plastics such as shrink fit foil and need only surround the foil bag in parts. DE 10254313 discloses moulded detergent products with at least one cavity with film sealing the openings in which the film surrounds the moulding as a sleeve or cover. JP 2004 155019 A discloses a hard chloroethylene resin sheet which is subjected to vacuum forming or pressure forming to form a packaging sheet.

DE 10245260 A1 discloses the production of detergent portions in closely fitting water-soluble packaging. The production process comprises 1) laying a water-soluble base film on a conveyor chain or mold, 2) applying the portion to the base film, 3) laying a film on top, 4) adjusting the films to enclose the portion and 5) sealing and optionally cutting the films.

WO 2006/095190 discloses a process for packaging compacted particulate compositions by which the resistance of the composition to physical damage is increased. As such, a wider range of physical properties of the compacted particulate composition can be tolerated, such as reduced hardness and increased friability, thus allowing a wider window of ingredient selection and manufacturing tolerances. In general terms, this document discloses the wrapping of a particulate composition with a web of film to form a tube with a longitudinal seam. The two ends of the tube are sealed around the product being packaged by transverse seams. In forming the transverse seams the longitudinal seam is brought next to the surface of the packaged product and is normally disposed in the middle of the rear face of the packaging.

This method of wrapping compacted particulate compositions with a film of material is straightforward and economical, when compared to, for example, dipping or spray coating.

Nevertheless, this straightforward form of wrapping does cause drawbacks to the resulting wrapped compacted particulate composition however. One such drawback is that the transverse seams protrude and may inadvertently possess a sharp edge. Without careful handling these resulting sharp edges can easily cause a user handling the packaging to cut themselves.

A further safety issue can occur from the appearance of the transverse seams. It is reasonably commonplace for users of the packaging to not be aware that the packaging possesses an outer film that will disintegrate/dissolve/or the like when in use. Thus, when the users notice the protruding transverse seams they may attempt to tear the film open to expose the compacted particulate contained therein. Typically such compacted particulates contain materials that it would be preferable for a user not to directly contact without washing the contacted area shortly afterwards. Thus, this misuse of the package could cause a safety issue.

Furthermore, the presence of transverse seams fails to produce a package that is aesthetically acceptable from a consumer perspective.

In order to address the drawbacks with the prior art the inventors have sought an improved process that eliminates or alleviates the abovementioned drawbacks as well as addresses further drawbacks with the prior art not exemplified above.

### SUMMARY OF INVENTION

According to a first aspect of the present invention therefore, there is provided a process for the preparation of a package containing a compacted particulate composition sealed in at least one film, the process comprising the application of one or more pressing means on at least one protruding seam of the sealed film such that said at least one seam is rendered substantially congruous with a surface of the compacted particulate composition.

It is to be understood that extruded and injected moulded compositions are to be classed as compacted particulate compositions

A sealed compacted particulate composition sealed in at least one film, hereinafter referred to as the sealed composition, is moved into contact with the pressing means by any suitable method of conveyance. Such conveyance may be provided in the form of a conveyer belt system. Alternatively a system of guide channels or the like may be provided to allow the sealed composition to move from a first location to a lower location to meet the pressing means under the force of gravity. Combinations of conveyance methods may be used, for example, pressurized air flow piping may be utilized.

The at least one protruding seam is preferably rendered congruous with a surface or surfaces of the sealed composition to which it is adjacent. Alternatively, the at least one protruding seam may be rendered congruous with a predetermined surface(s) of the sealed composition, this surface(s) possibly being selected by selecting the orientation of the sealed composition when it meets the one or more pressing means.

Before contact is made between the sealed composition and the pressing means, the sealed composition is preferably orientated such that at least one protruding seam will immediately make contact therewith. The sealed composition may be orientated such that all protruding seams will immediately make contact with the pressing means when the sealed composition and pressing means meet each other.

Preferably the pressing means are provided in the form of a pair of pressing means. The pair of pressing means may be orientated opposite each other and spaced apart at a distance equal to or less than the width of the sealed composition, thereby permitting the pressing means to impart a pressing force at least on the film of the sealed composition.

Alternatively, the pair of pressing means may spaced apart, at a distance equal to or less than the width of the sealed composition, to be contactable with opposite sides of a sealed composition, wherein said pair of pressing means have a staggered location with respect to each other.

As a further alternative, there may be three or more pressing means spaced apart at a distance equal to or less than the width and/or height of the sealed composition, to be contactable with a unique side of a sealed composition relative to each other.

As a further alternative, there may be a plurality of pressing means spaced apart from each other wherein said plurality of pressing means may be contactable, either simultaneously or sequentially, to at least two substantially opposite sides of a sealed composition.

It is to be understood that the use of the words “width” or “height” is not intended to impose a specific orientation upon the operation of the process, rather the “width” or “height” is a variable dimension of the sealed composition depending on the orientation of the composition relative to the pressing means when they come into contact with each other.

In a preferred embodiment of the invention, the pressing means are a pair of rollers.

The pressing means may have one or more deformable surface, preferably one or more resiliently deformable surface. The deformable surface(s) may permit the pressing means to more completely press the seam or seams of the film to better render the seam(s) substantially congruous with a surface(s) of the sealed composition.

Providing pressing means with resiliently deformable surface(s) may be particularly suitable when a pair of pressing means are orientated opposite each other and spaced apart at a distance less than the width of the sealed composition. This orientation may permit the pressing means to deform as a front edge of the sealed composition passes through the pressing means to press around some or all of the edge, thus pressing one seam or part of two seams toward the composition. As the sealed composition continues through the pressing means, a pressing force is applied thereby to the side edges of the composition, thus pressing any protruding seam(s) toward the surface of said side edge. Finally, as a rear edge of the sealed composition is about to exit the pressing means, the resilience of the deformable surfaces may permit these surfaces to press around some or all of the rear edge, thus pressing the other seam or the remaining part of the two seams toward the composition, thereby rendering the seam(s) substantially congruous with the surface(s) of the sealed composition.

In a preferred embodiment of the present invention, at least the outer portion of the pressing means is made from an elastomer gum, preferably natural rubber.

The pressing means, particularly when provided in the form of rollers, may be provided with a non-deformable core, which may be adapted to be engaged with a propulsion means, covered with a resiliently deformable material which will, in use, contact the sealed composition.

Alternatively, the pressing means, particularly when provided in the form of rollers, may be made entirely of a resiliently deformable material, the core of which may be adapted to be engaged with a propulsion means.

In a further alternative embodiment, the pressing means, particularly when provided in the form of rollers, may be provided with a non-deformable core, which may be adapted to be engaged with a propulsion means, covered with a deformable material which will, in use, contact the sealed composition.

Alternatively the pressing means may be resiliently movable in a substantially perpendicular direction relative to the direction of travel of the sealed composition. This resiliently movable capability may permit the pressing means to more completely press the seam or seams of the film to better render the seam(s) substantially congruous with a surface(s) of the sealed composition.

Providing pressing means with the ability to be resiliently movable may also be particularly suitable when a pair of pressing means are orientated opposite each other and spaced apart at a distance less than the width of the sealed composition. This orientation may permit the pressing means to move outwardly in a substantially perpendicular direction as a front edge of the sealed composition passes through the pressing means to press around some or all of the edge, thus pressing one seam or part of two seams toward the composition. As the sealed composition continues through the pressing means, a pressing force is applied thereby to the side edges of the composition, thus pressing any protruding seam(s) toward the surface of said side edge. Finally, as a rear edge of the sealed composition is about to exit the pressing means, the resilience of the pressing means may cause the means to move perpendicularly toward the sealed composition to press around some or all of the rear edge, thus pressing the other seam or the remaining part of the two seams toward the composition, thereby rendering the seam(s) substantially congruous with the surface(s) of the sealed composition.

In order to increase the efficiency with which the pressing means renders the seam(s) substantially congruous with the surface(s) of the sealed composition the pressing means may be provided with the ability to further treat the film beyond the ability to apply a pressing force. Examples of suitable further treatment abilities of the pressing means to treat the film include: a heating ability; a radiation emitting ability, such as infra-red, RF, UV, etc; a solvent application ability, whereby the pressing means may also apply a solvent to the film; and/or an adhesive application ability, whereby the pressing means may also apply an adhesive to the film; as well as combinations of one or more of these abilities.

In a preferred embodiment the pressing means are provided with a propulsion means in order to propel the sealed composition through the pressing means. Particularly preferably, the propulsion means is adapted to propel the sealed composition through the pressing means at a velocity equal or greater than the velocity at which the sealed composition arrives at the pressing means. This preferred increase in velocity may be advantageous as it is likely to prevent incoming sealed compositions coming into contact with sealed compositions already in contact with the pressing means.

For instance, where the pressing means is provided in the form of a pair of rollers, the propulsion means may operate to rotate the rollers in opposite directions to each other, i.e. clockwise and counter-clockwise, thus propelling a sealed composition between the rollers.

Other suitable forms of propulsion means may be utilized depending on the specific form of the pressing means employed in the process. For instance, where the pressing means are provided in the form of rollers, said rollers may be substantially torque-free rather than be connected to any propulsion means, whereby the linear movement of the sealed composition is sufficient to permit the composition to pass through the rollers. Alternatively, the linear movement of the sealed composition through substantially torque-free rollers could be facilitated by separate conveyance means.

In known processes, such as those described in the background above, the processing of a compacted particulate composition operates using linear speeds of approximately less than 5 meters/minute. It is preferred that the process in accordance with the first aspect of the present invention operates at a speed of greater than 5 meters/minute, more preferably between 50-150 meters/minute, and most preferably between 80-120 meters/minute.

Where the pressing means is provided in the form of spaced apart rollers, they are preferably capable of operating at rotational speeds in the order of 5-500 rpm depending on the circumference of the roller to ensure a satisfactory linear speed of the sample composition. More preferable rotational speeds are between 25-250 rpm and most preferably are speeds between 100-200 rpm.

It may also be advantageous for the sealed composition to be brought into contact with the pressing means as soon as practicably possible after being sealed and/or, where applicable, heat shrunk. Indeed, where the at least one film is of a heat shrink-type is used, permitting the film(s) to contact the pressing means whilst the film still has some residual heat therein, after the application of heat during the shrinking process, may be advantageous. As such, it is preferable that the linear speed at which the sealed composition is brought into contact with the pressing means is increased over the prior art speeds. Therefore, it is preferable to linearly propel the sealed composition toward the pressing means at a speed of >5 meters/minute, more preferably between 25-120 meters/minute, and most preferably between 80-100 meters/minute; these speeds being subject to being lower than the speed at which the sealed composition is propelled through the pressing means.

As mentioned above, the process is preferably configured such that the sealed composition is brought into contact with the pressing means as soon as is practicably possible after being sealed and/or, where applicable, heat shrunk. As such, it is preferred that the sealed composition is brought into contact with the pressing means <2.5 seconds after being sealed and/or, where applicable, heat shrunk, and more preferably between 0.08-2.5 seconds, and most preferably between 0.10-0.15 seconds.

Preferably the at least one film is a heat-shrink film(s). Specifically, that is a film(s) possessing a tendency to shrink when exposed to heat. Using at least one heat shrink film in the sealed composition may be advantageous as the film(s) can be shrunk upon the application of heat to form a tight fit around the compressed particulate.

Advantageously, where the at least one film is a heat-shrink film and the film(s) has been heat-shrunk around a compacted particulate composition, the film(s) may be able to have its interior volume substantially completely filled with the compacted particulate composition. Preferably, the heat-shrink film can have between 65-100% of its interior volume filled, and most preferably between 85-100% filled.

Additionally, where the at least one film is a heat-shrink film, it can be advantageous for the rapid linear speeds of movement of the sealed composition mentioned above as the heat-shrink film may still be sufficiently hot from the application of heat during the heat-shrinking process to assist in the rendering of the protruding seam(s) substantially congruous with a surface of the composition.

Linearly downstream of the pressing means there may be provided a freezing means. The freezing means is preferably operable to assist in securing the shape of the film after it has been contacted by the pressing means. The freezing means may be operable to expose the sealed compositions to a reduction in temperature, this would be particularly useful where the film has heat shrink-type properties. Alternatively, or perhaps additionally, the freezing means may be operable to spray or coat the sealed composition with an adhesive or solvent in order to secure the shape of the film.

Alternatively, the freezing means may be disposed to be operable simultaneously with the operation of the pressing means.

Advantageously, a preferable effect resulting from the application of the process of present invention on a sealed composition is that the seam(s) is devoid of sharp edges. A further preferred effect is that the resulting smoothed edges does not provide a user with a surface upon which they can easily get a purchase. A yet further preferred effect is that the smoothed edges where the protruding seams had been do not provide a user with a visual suggestion that the film could or should be opened to expose the compacted particulate composition, thus the likelihood of safe use of the resultant package is greatly increased.

According to a second aspect of the present invention there is provided a process for the preparation of a package containing a compacted particulate composition, comprising:
wrapping a compacted particulate composition with at least one film;
sealing the at least one film around said compacted particulate composition; and
subsequently applying one or more pressing means on at least one protruding seam of the sealed film such that said at least one seam is rendered substantially congruous with a surface of the compacted particulate composition.

Preferably the step of wrapping of the compacted particulate composition employs flow wrapping.

The wrapped packages produced in accordance with the first and second aspects of the present invention do not easily fracture or chip, even when packaged together in a secondary package. Thus the film does not function merely to hold fractured tablets together; instead it prevents fracturing from occurring so that the tablet retains its structural integrity and without possessing potentially harmful sharp protruding seams. This has the effect that a smaller amount of binder (commonly used in compacted particulate compositions) can be used without compromising on their integrity; and/or that a lower compaction pressure can be used; and/or that a compacted particulate composition of modest or even poor inherent mechanical properties may be used, protected and/or retained by the wrapping; and/or that a fast-dissolving product can be made.

Preferably the package produced in accordance with any aspect of the present invention is readily soluble in water.

Furthermore, fast-dissolving compacted particulate compositions can be made in accordance with the invention, using a reduced compaction pressure. For example a 20 g tablet of fast-dissolving type made in accordance with the present invention may dissolve in water at 40° C. under standard test conditions of agitation as mentioned in the examples hereinafter, in less than 10 minutes, preferably in less than 5 minutes. Preferably these dissolution rates may be achieved by all known agitation methods used in dishwasher tablet dissolution testing.

In an alternative, simple definition a 20 g tablet may be immersed in 800 ml of tap water at 40° C., in a 1 litre cylindrical beaker, which is then agitated (which may include swirling) by grasping the beaker by hand and/or by a hand-held tool immersed in the water but not permitted to come into contact with the tablet, the resulting agitation being to the maximum extent possible without causing water to spill from the beaker. Under these conditions tablets of the present invention preferably dissolve in less than 10 minutes, preferably less than 5 minutes.

The film is preferably sealed together in a known manner. Sealing can simply occur under the forming conditions used in the process of the present invention, particularly when heat and/or pressure are used. However, it is also possible for additional sealing techniques to be used. For example, heat sealing or infra-red, radio frequency, ultrasonic, laser, solvent, adhesive, vibration, electromagnetic, hot gas, hot plate or insert bonding friction sealing, cold sealing or spin welding can be used. Heat sealing is preferred.

Heat sealing conditions depend on the machine and material used. Generally the sealing temperature is from 100 to 180° C. The pressure is usually from 100 to 500 kPa (1 to 5 bar). The dwell time is generally from 0.02 to 0.6 seconds.

In a preferred embodiment of any aspect of the invention, a heat treatment step may be carried out over a short timescale to avoid thermal damage to the film and/or the compacted particulate composition. It will be appreciated that the amount of time required for this step will be dependent on the thickness of the film being used. Generally the heat treatment step is carried out in a time of 0.1 to 5 seconds, more preferably 0.2 to 4 seconds, more preferably 0.5 to 2 seconds, more preferably 1.0 to 2.0 seconds, e.g. about 1.5 seconds.

Most preferably the heat treatment step is carried out in a zone through which the wrapped composition is conveyed. In this way it has been found that the heat treatment step may form part of a production process for a wrapped compacted particulate composition wherein the process includes other steps, such as the compaction of the composition. Such processes generally operate at around 1500 individual compacted particulate compositions per minute on a single operational line. It has been found that advantageously the process of the present invention is able to work with this rate of throughput.

Generally the zone comprises a flow (e.g. in the form of jets) of hot air over the wrapped compacted particulate compositions. Preferably a plurality of jets of hot air are passed over the wrapped composition. For example a jet of air may be directed at the composition from above, a jet of air may be directed at the composition from below and a jet of air may be directed at one or more sides of the composition. In order that multiple jets of air may be directed at the wrapped composition preferably the composition is carried on an apertured conveyor through the zone.

It will be understood that the temperature of the jets of air will depend upon the nature of the wrapped composition (particularly if the composition is thermally sensitive) and the film, material being used. Generally the air is heated to a temperature of between 90 to 950° C., more preferably 140 to 800° C., more preferably 180 to 650° C.

It will be appreciated that the film temperature may be lower than the temperature of the air jet. Most preferably the film temperature is between 80 to 220° C. and more preferably 120 to 180° C.

Generally the film has an aperture to allow the release of any trapped air during the heating process. Most preferably the film (when applied to the compacted particulate composition) has a plurality of apertures. Preferably the apertures are disposed on the upper surface of the particulate composition. Usually the apertures are applied using a punch. The apertures have a preferred size (before the heat treatment step) of from around 0.1 to 0.3 mm.

In the process the thickness of the at least one film is preferably 10 to 2000 μm, more preferably 10 to 150 μm and most preferably 15 to 80 μm. These measurements are before heat treatment; after heat treatment portions of the film(s) may have a different thickness, particularly around corners.

Desirably the at least one film is water soluble, which term is taken to include water-dispersible. The resultant package of any aspect of the present invention is also preferably water-soluble. A water soluble film(s) allows the product of the process of the invention to be dispersed in an aqueous medium without having to be unwrapped.

Preferably the film comprises a polymeric material.

Examples of water-soluble polymers are PVOH, cellulose derivatives such as hydroxypropyl methyl cellulose (HPMC), gelatin, poly(vinylpyrrolidone), poly(acrylic acid) or an ester thereof or poly(maleic acid) or an ester thereof. Copolymers of any of these polymers may also be used.

An example of a preferred PVOH is an esterified or etherified PVOH. The PVOH may be partially or fully alcoholised or hydrolysed. For example it may be from 40 to 100%, preferably from 70 to 92%, more preferably about 88% or about 92%, alcoholised or hydrolysed. The degree of hydrolysis is known to influence the temperature at which the PVOH starts to dissolve in water. 88% hydrolysis corresponds to a PVOH soluble in cold (ie room temperature) water, whereas 92% hydrolysis corresponds to a PVOH soluble in warm water.

By choosing an appropriate water-soluble polymer it is possible to ensure that it dissolves at a desired temperature. Thus the film may be cold water (20° C.) soluble, but may be insoluble in cold water and only become soluble in warm or hot water having a temperature of, for example, 30° C., 40° C., 50° C. or even 60° C.

Desirably the film(s) consists essentially of, or consists of, the polymer composition. It is possible for suitable additives such as plasticisers, lubricants and colouring agents to be added. A particularly attractive appearance can be achieved by having the films in different colours, or by having one film uncoloured and the other coloured. Components which modify the properties of the polymer may also be added. Plasticisers are generally used in an amount of up to 20 wt %, for example from 5 to 20 wt % or 10 to 20 wt %. Lubricants are generally used in an amount of 0.5 to 5 wt %. The polymer is therefore generally used in an amount of from 75 to 94.5 wt %, based on the total amount of the moulding composition. Suitable plasticisers are, for example, water, pentaerythritols such as depentaerythritol, sorbitol, mannitol, glycerine and glycols such as glycerol, ethylene glycol and polyethylene glycol. Solids such as talc, stearic acid, magnesium stearate, silicon dioxide, zinc stearate or colloidal silica may be used as lubricants.

It is also possible to include one or more particulate solids in the films in order to accelerate the rate of dissolution of the film. Dissolution of the solid in water is sufficient to cause an acceleration in the break-up of the film, particularly if a gas is generated.

Examples of such solids are alkali and alkaline earth metal, such as sodium, potassium, magnesium and calcium, bicarbonate and carbonate, in conjunction with an acid.

Suitable acids are, for example acidic substances having carboxylic or sulfonic acid groups or salts thereof. Examples are cinnamic, tartaric, mandelic, fumaric, maleic, malic, palmoic, citric and naphthalene disulfonic acids, as free acids or as their salts, for example with alkali or alkaline earth metals.

The film(s) may be a single film, or a laminated film as disclosed in GB-A-2,244,258. The layers in a film laminate may be the same or different. Thus the layers may each comprise the same polymer or a different polymer.

The film(s) may be produced by any process, for example by extrusion and blowing or by casting. The film may be unoriented, monoaxially oriented or biaxially oriented. If the layers in the film are oriented, they usually have the same orientation, although their planes of orientation may be different if desired.

The process of the present invention covers or wraps a compressed particulate composition in a film to produce a sealed composition before being processed into the form of a package in accordance with any aspect of the present invention. The package may be equivalent to a conventional tablet of the type which is already known. It is postulated, although again the applicant is not bound by this theory, that the increased strength of such a tablet arises from the interaction of the outer polymer film and the surface of the tablet and/or compression of the tablet by the outer film.

The compacted particulate composition is formed by compressing a particulate composition. The particles may, if desired, be treated before they are compressed, for example by agglomeration and/or granulation. The composition before it is compressed may, for example, have a mean particle size of from 100 to 2000 μm, preferably 200 to 1200 μm.

The compacted particulate composition may be compressed at a compression pressure of, for example, from 50 to 1000 kg/cm², preferably from 60 to 300 kg/cm² for laundry tablets or from 50 to 1000 kg/cm², more preferably from 100 to 700 kg/cm², for dishwashing tablets. For dishwashing tablets having good inherent mechanical properties preferred ranges may be 400 to 1000 kg/cm², more preferably from 500 to 700 kg/cm². For dishwashing tablets having poorer inherent mechanical properties and/or especially fast dissolution properties preferred ranges may be 150-400 kg/cm², preferably 160-350 kg/cm², most preferably 170-300 kg/cm². These definitions refer to nominal compression forces which one would set on the particular tablet press being used for making the tablets. The stipulation is that on any given press which is in use the nominal compression force should be within one or more of the ranges stated above.

Suitably the compacted particulate composition part of the package, that is the unwrapped core, is highly friable. Preferably the package is not friable.

Standard tests are available for friability including one which follows in the examples. In accordance with this aspect of the invention the difference between “non-friable” and “highly friable” is so marked—as shown in later examples that further definition is not thought necessary.

Preferably the compacted particulate composition part of the package of the present invention is softer than conventional compacted particulate compositions. The latter typically have hardness values in the range 230-260 N. Preferably the compacted particulate composition part of the package of the present invention has a hardness value not exceeding 200 N, preferably not exceeding 150 N. Preferably the compacted particulate composition part of the package of the present invention has a hardness value of at least 80 N, preferably at least 100 N. For the purpose of these definitions the hardness testing may be as determined across the width of a standard shaped cuboid 20 g unwrapped tablet, tested to destruction, using an ERWEKA tablet hardness tester THB30. In this tester the tablet is set on a generally L-shaped support, against the upwardly projecting limb thereof. A circular piston of 8 mm diameter is advanced at a rate of 30 mm per minute and pressed onto the central region of the respective side wall, until the tablet is broken.

Alternatively the hardness definitions herein may be regarded as being such that they must be satisfied by all hardness testing equipment/regimens used for testing dishwashing tablets.

Preferably the compacted particulate composition part of the package of the present invention is able to help its shape in the absence of applied stresses but is quickly degraded by applied stresses. Shear stresses may readily cause it to flake and crumble. Compressive stresses may readily cause it to be crushed. However the provision of a heat-shrunk water-soluble wrapper obviates these defects, permits clean handling, and allows the major benefit of fast dissolution to be exploited.

The compacted composition may be of any shape or form. It is most desirably in the form of a tablet. It may, for example, be in the form of a cuboid, cylinder or prism. It may also comprise a single particulate composition or two, three or even more compositions. For example, the compacted particulate composition may comprise two, three or more layers.

The packages may contain one or more than one compacted particulate composition. If the packages contain two or more compositions, they can have a particularly attractive appearance since the compositions, which may be identical or different, may be held in a fixed position in relation to each other. The compositions can be easily differentiated to accentuate their difference. For example, the compositions can have a different physical appearance, or can be coloured differently.

The packages may have any desired shape. The shape of the outside of the packages follows the shape of the packaged composition. For example the package can have a irregular or regular geometrical shape such as a cube, cuboid, pyramid, dodecahedron or cylinder. The cylinder may have any desired cross-section, such as a circular, triangular or square cross-section.

If the composition has two or more phases, the individual phases need not necessarily be regular or identical. For example, if the final composition has a cuboid shape, the individual phases may have different sizes to accommodate different quantities of compositions.

The compacted particulate composition may also, for example, comprise an insert, which may be held in a depression within the compact. The insert may also stand proud of the compact. For example, the compacted particulate composition may be in the form of a tablet, especially a cuboid tablet, comprising one, two or more layers, and an insert, for example in the form of a ball in a mould. An example of such a tablet is that sold under the trade mark Finish by Reckitt Benckiser plc.

The composition(s) which can be held in the package, or in each phase in the composition held in the package, may independently be a fabric care, surface care or dishwashing composition. Thus, for example, they may be a dishwashing, water-softening, laundry or detergent composition, or a rinse aid. Such compositions may be suitable for use in a domestic washing machine. The compositions may also independently be a disinfectant, antibacterial or antiseptic composition, or a refill composition for a trigger-type spray. Such compositions are generally packaged in total amounts of from 5 to 100 g, especially from 5 to 40 g. For example, a laundry composition may weigh from 15 to 40 g, a dishwashing composition may weigh from 5 to 30 g and a water-softening composition may weigh from 15 to 40 g.

The phases may have the same or different size and/or shape. In general, if it is desired to have phases containing different quantities of components, the phases have volume ratios of from 1:1 to 20:1, especially from 1:1 to 10:1.

The packages produced by the process of the present invention may, if desired, have a maximum dimension of 10 cm, excluding any flanges. For example, a container may have a length of 1 to 5 cm, especially 3.5 to 4.5 cm, a width of 1.5 to 3.5 cm, especially 2 to 3 cm, and a height of 1 to 3 cm, especially 1.0 to 2.0 cm, e.g. 1.8 cm.

If more than one composition is present, the compositions may be appropriately chosen depending on the desired use of the article.

If the article is for use in laundry washing, the primary composition may comprise, for example, a detergent, and the secondary composition may comprise a bleach, stain remover, water-softener, enzyme or fabric conditioner. The article is adapted to release the compositions at different times during the laundry wash. For example, a bleach or fabric conditioner is generally released at the end of a wash, and a water-softener is generally released at the start of a wash. An enzyme may be released at the start or the end of a wash.

If the article is for use as a fabric conditioner, the primary composition may comprise a fabric conditioner and the secondary component may comprise an enzyme which is released before or after the fabric conditioner in a rinse cycle.

If the article is for use in dishwashing the primary composition may comprise a detergent and the secondary composition may comprise a water-softener, salt, enzyme, rinse aid, bleach or bleach activator. The article is adapted to release the compositions at different times during the laundry wash. For example, a rinse aid, bleach or bleach activator is generally released at the end of a wash, and a water-softener, salt or enzyme is generally released at the start of a wash.

Examples of surface care compositions are those used in the field of surface care, for example to clean, treat or polish a surface. Suitable surfaces are, for example, household surfaces such as worktops, as well as surfaces of sanitary ware, such as sinks, basins and lavatories.

The ingredients of each composition depend on the use of the composition. Thus, for example, the composition may contain surface active agents such as an anionic, non-ionic, cationic, amphoteric or zwitterionic surface active agents or mixtures thereof.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols. Examples of primary alkyl sulfate surfactants are those of formula:

ROSO₃⁻M⁺

wherein R is a linear C₈-C₂₀ hydrocarbyl group and M is a water-solubilising cation. Preferably R is C₁₀-C₁₆ alkyl, for example C₁₂-C₁₄, and M is alkali metal such as lithium, sodium or potassium.

Examples of secondary alkyl sulfate surfactants are those which have the sulfate moiety on a “backbone” of the molecule, for example those of formula:

CH₂(CH₂)ₙ(CHOSO₃⁻M⁺)(CH₂)ₘCH₃

wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:

CH₂(CH₂)ₓ(CHOSO₃⁻M⁺)CH₃ and

CH₃(CH₂)ₓ(CHOSO₃⁻M⁺)CH₂CH₃

for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:

RO(C₂H₄O)ₙSO₃⁻M⁺

wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates.

The alkyl sulfates and alkyl ether sulfates will generally be used in the form of mixtures comprising varying alkyl chain lengths and, if present, varying degrees of alkoxylation.

Other anionic surfactants which may be employed are salts of fatty acids, for example C₈-C₁₆ fatty acids, especially the sodium or potassium salts, and alkyl, for example C₈-C₁₈, benzene sulfonates.

Examples of non-ionic surfactants are fatty acid alkoxylates, such as fatty acid ethoxylates, especially those of formula:

R(C₂H₄O)ₙOH

wherein R is a straight or branched C₈-C₁₆ alkyl group, preferably a C₉-C₁₅, for example C₁₀-C₁₀ alkyl group and n is at least 1, for example from 1 to 16, preferably 2 to 12, more preferably 3 to 10.

The alkoxylated fatty alcohol non-ionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol non-ionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated non-ionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further non-ionic surfactants are, for example, C₁₀-C₁₈ alkyl polyglycosides, such as C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

Examples of cationic surfactants are those of the quaternary ammonium type.

The compositions, particularly when used as laundry washing or dishwashing compositions, may also independently comprise enzymes, such as protease, lipase, amylase, cellulase and peroxidase enzymes. Such enzymes are commercially available and sold, for example, under the registered trade marks Esperase, Alcalase and Savinase by Nova Industries A/S and Maxatase by International Biosynthetics, Inc. Desirably the enzymes are independently present in the compositions in an amount of from 0.01 to 3 wt %, especially 0.01 to 2 wt %, when added as commercial preparations they are not pure and this represents an equivalent amount of 0.005 to 0.5 wt % of pure enzyme.

Compositions used in dishwashing independently usually comprise a detergency builder. The builders counteract the effects of calcium, or other ion, water hardness. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-C₂₂ fatty acids and citric acid. Other examples are organic phosphonate type sequestering agents such as those sold by Monsanto under the trade mark Dequest and alkylhydroxy phosphonates. Citrate salts and C₁₂-C₁₈ fatty acid soaps are preferred. Further builders are; phosphates such as sodium, potassium or ammonium salts of mono-, di- or tri-poly or oligo-phosphates; zeolites; silicates, amorphous or structured, such as sodium, potassium or ammonium salts.

Other suitable builders are polymers and copolymers known to have builder properties. For example, such materials include appropriate polyacrylic acid, polymaleic acid, and polyacrylic/polymaleic and copolymers and their salts, such as those sold by BASF under the trade mark Sokalan. The builder is desirably present in an amount of up to 90 wt %, preferably 0.01 to 90 wt %, more preferable 0.01 to 75 wt %, relative to the total weight of the composition. Further details of suitable components are given in, for example, EP-A-694,059, EP-A-518,720 and WO 99/06522.

The compositions can also optionally comprise one or more additional ingredients. These include conventional detergent composition components such as further surfactants, bleaches, bleach enhancing agents, builders, suds boosters or suds suppressors, anti-tarnish and anti-corrosion agents, organic solvents, co-solvents, phase stabilisers, emulsifying agents, preservatives, soil suspending agents, soil release agents, germicides, pH adjusting agents or buffers, non-builder alkalinity sources, chelating agents, clays such as smectite clays, enzyme stabilizers, anti-limescale agents, colourants, dyes, hydrotropes, dye transfer inhibiting agents, brighteners, and perfumes. If used, such optional ingredients may constitute up to 60 wt %, for example from 1 to 50 wt %, the total weight of the compositions.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.01 to 2 wt % of the compositions.

The compositions may optionally comprise materials which serve as phase stabilizers and/or co-solvents. Examples are C₁-C₃ alcohols such as methanol, ethanol and propanol. C₁-C₃ alkanolamines such as mono-, di- and triethanolamines can also be used, by themselves or in combination with the alcohols. The phase stabilizers and/or co-solvents can, for example, constitute 0 to 1 wt %, preferably 0.1 to 0.5 wt %, of the composition.

The compositions may optionally comprise components which adjust or maintain the pH of the compositions at optimum levels. The pH may be from, for example, 1 to 13, such as 8 to 11 depending on the nature of the composition. For example a dishwashing composition desirably has a pH of 8 to 11, a laundry composition desirable has a pH of 7 to 9, and a water-softening composition desirably has a pH of 7 to 9. Examples of pH adjusting agents are soda ash (Na₂CO₃) and citric acid.

The above examples may be used for dish or fabric washing. In particular dish washing formulations are preferred which are adapted to be used in automatic dish washing machines.

Due to their specific requirements specialised formulation is required and these are illustrated below

Amounts of the ingredients can vary within wide ranges, however preferred automatic dishwashing detergent compositions herein (which typically have a 1% aqueous solution pH of above 7, more preferably from 8 to 12, most preferably from 8 to 10.5) are those wherein there is present: from 5% to 90%, preferably from 5% to 75%, of builder; from 0.1% to 40%, preferably from 0.5% to 30%, of bleaching agent; from 0.1% to 15%, preferably from 0.2% to 10%, of the surfactant system; from 0.0001% to 1%, preferably from 0.001% to 0.05%, of a metal-containing bleach catalyst; and from 0.1% to 40%, preferably from 0.1% to 20% of a water-soluble silicate. Such fully-formulated embodiments typically further comprise from 0.1% to 15% of a polymeric dispersant, from 0.01% to 10% of a chelant, and from 0.00001% to 10% of a detersive enzyme, though further additional or adjunct ingredients may be present. Detergent compositions herein in granular form typically limit water content, for example to less than 7% free water, for better storage stability.

Non-ionic surfactants useful in ADW (Automatic Dish Washing) compositions of the present invention desirably include surfactant(s) at levels of up to 15% of the composition. In general, bleach-stable surfactants are preferred. Non-ionic surfactants generally are well known, being described in more detail in Kirk Othmer's Encyclopedia of Chemical Technology, 3rd Ed., Vol. 22, pp. 360-379, “Surfactants and Detersive Systems”, incorporated by reference herein.

Preferably the ADW composition comprises at least one non-ionic surfactant. One class of non-ionics are ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol.

Particularly preferred non-ionic surfactants are the non-ionic from a linear chain fatty alcohol with 16-20 carbon atoms and at least 12 moles particularly preferred at least 16 and still more preferred at least 20 moles of ethylene oxide per mole of alcohol.

According to one preferred embodiment the non-ionic surfactant additionally comprise propylene oxide units in the molecule. Preferably this PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of non-ionic surfactants includes reverse block copolymers of polyoxyethylene and polyoxypropylene and block copolymers of polyoxyethylene and polyoxypropylene initiated with trimethylolpropane.

Another preferred non-ionic surfactant can be described by the formula:

R¹O[CH₂CH(CH₃)O]_{X}[CH₂CH₂O]_{Y}[CH₂CH(OH)R²]

wherein R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]_{X}[CH₂]ₖCH(OH)[CH₂]ⱼOR²

wherein R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. H, methyl or ethyl are particularly preferred, for the group R³. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (HO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (HO) or (PO) units would arise.

Particularly preferred end-capped polyoxyalkylated alcohols of the above formula are those where k=1 and j=1 originating molecules of simplified formula:

R¹O[CH₂CH(R³)O]_{X}CH₂CH(OH)CH₂OR²

The use of mixtures of different non-ionic surfactants is particularly preferred in ADW formulations for example mixtures of alkoxylated alcohols and hydroxy group containing alkoxylated alcohols.

The packages may themselves be packaged in outer containers if desired, for example non-water soluble containers which are removed before the water-soluble packages are used.

In use one or more packages are simply added to water where the outside dissolves. Thus they may be added in the usual way to a dishwasher or laundry machine, especially in the dishwashing compartment or a drum. They may also be added to a quantity of water, for example in a bucket or trigger-type spray.

In accordance with a third aspect of the present invention there is provided a ware-washing package of compacted particulate composition produced in accordance with either the first or the second aspect of the present invention, wherein the package has a heat-shrunk film, wherein the package is preferably a dishwashing package.

In accordance with a fourth aspect of the present invention there is provided a fabric-washing package of compacted particulate composition produced in accordance with either the first or the second aspect of the present invention, wherein the package has a heat-shrunk film.

In accordance with a fifth aspect of the present invention there is provided a surface-care package of compacted particulate composition produced in accordance with either the first or the second aspect of the present invention, wherein the package has a heat-shrunk film.

### BRIEF DESCRIPTION OF THE DRAWINGS

Embodiments of the invention will now be described, by way of example only, with reference to the following drawings in which:

FIG. 1 illustrates a plan view of a pressing means apparatus;

FIG. 2 illustrates a perspective view of a front side of said pressing means apparatus; and

FIG. 3 illustrates a perspective view of a rear side of said pressing means apparatus.

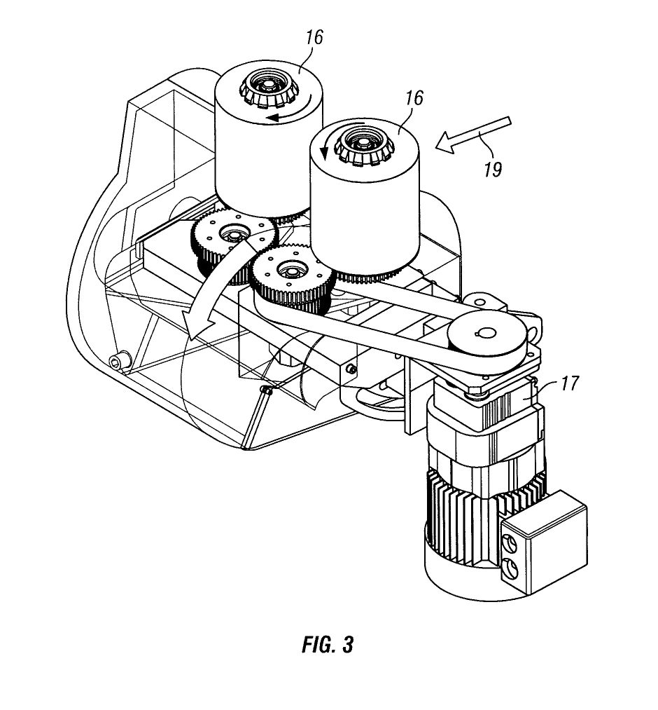

### DESCRIPTION OF AN EMBODIMENT

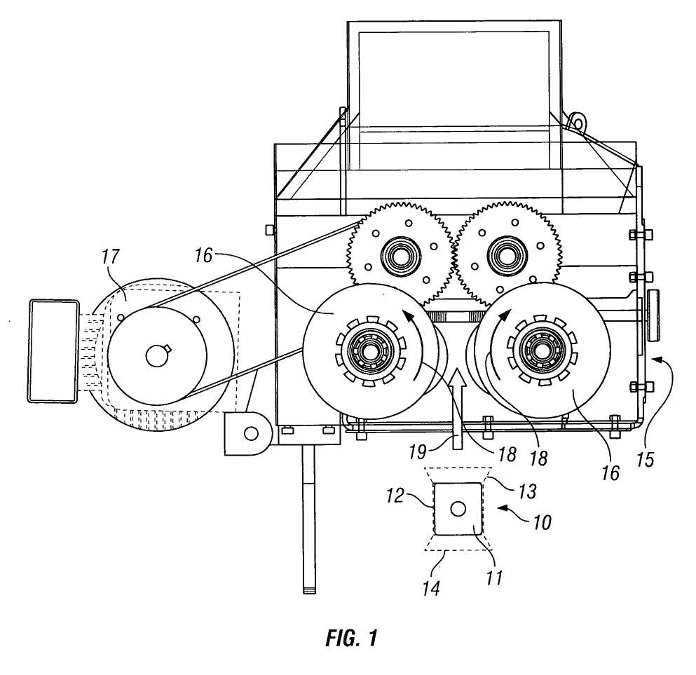

In FIG. 1 there is shown a sealed composition (10) comprising a compacted particulate composition (11) sealed within at least one film (12), which in this particular case is a heat shrink-type film by way of example. The film possesses a pair of transverse seams (13,14) that were created when the at least one film (12) was sealed.

After being sealed, such sealing being achieved using any suitable process, the sealed composition (10) is propelled toward pressing means apparatus (15). This apparatus comprises a pair of spaced apart rollers (16) located opposite each other. The rollers (16) are preferably spaced apart at a distance equal to or less than the width of the sealed composition (10). The rollers (16) are operably connected to a motor (17) which is operable to rotate the rollers in opposite directions to each other as shown by the directional arrows (18). It is preferable for the motor (17) to be operable to rotate the rollers (16) at speeds of between 5-500 rpm, but preferably at speeds between 100-200 rpm.

The arrow (19) illustrates the direction of linear movement of the sealed composition (10) toward the pressing means apparatus (15). The surface of the rollers (16) is adapted to be resiliently deformable such that when the sealed composition (10) contacts the rollers (16), they partially deform to accommodate the width of the sealed composition (10) to permit the rollers to more completely press the seams (13,14) and better render them congruous with the surface of the sealed composition (10).

The specific mode of operation of the rollers (16) is as follows. On contact being made between the rollers (16) and the front edge (or lead edge) of the sealed composition (10), the rollers (16) resiliently deform and thus apply a pressing means around some or all of the front edge. The effect of this pressing on the front edge captures the seam (13) between the edge and the rollers (16), thus pressing the seam (13) toward the composition.

As the sealed composition (10) continues through the pressing means, a pressing force is continually applied by the rollers (16) to the side edges of the composition, thus pressing any remainder of the seam (13) toward the surface of said side edges. Finally, as the other seam (14) is about to exit the rollers (16), the resilient nature of the rollers permits them to press around some or all of the rear edge, thus pressing the other seam (14) toward the rear edge, thereby rendering both seams (13,14) substantially congruous with the surface of the sealed composition (10).

Although not shown, the sealed composition (10) may be rotated 90 degrees such that its orientation permits both seams (13,14) to substantially simultaneously make contact with the pair of rollers (16) when the composition (10) is brought into contact therewith.

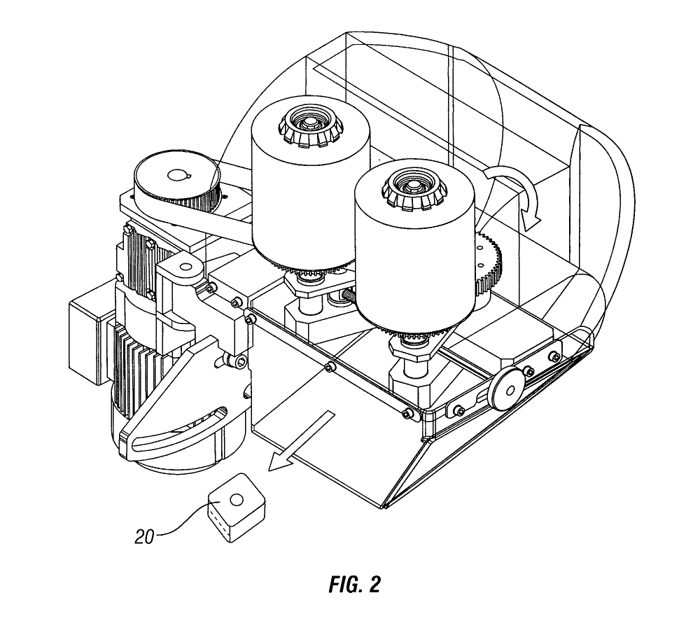

In FIGS. 2 & 3 the onward travel of the sealed composition (10) is also illustrated. Once the sealed composition (10) has been pressed by the rollers (16) and the seams (13,14) pressed toward the surface of the composition (10), the resulting package (20) is ejected from the apparatus. The at least one film (12) entirely encapsulating the compacted particulate material (11) of the package (20) and the film(s) (12) possessing smooth edges with no protruding or sharp seams.

Where the at least one film (12) is a heat shrink-type film(s), the pressing of the resiliently deformable rollers (16) on the seams (13,14) toward the surface of the sealed composition (10) may be sufficient to secure the seams (13,14) substantially permanently thereagainst and congruous with said surface as there may be enough residual heat in the film(s). Alternatively or additionally, the rollers (16) may be able to impart heat, radiation, a solvent or an adhesive in order to secure the seams (13,14).

Although not shown, a freezing means may also be present downstream of the pressing means apparatus (15), or within the apparatus (15) but downstream of the pressing mechanism, in the illustrated case, the rollers (16). The freezing means being operable to assist in securing the seams (13,14) of the film (12) after it has been contacted by the rollers (16). The freezing means may be operable to expose the sealed compositions to a reduction in temperature, this would be particularly useful where the film (12) has heat shrink-type properties. Alternatively, or perhaps additionally, the freezing means may be operable to spray or coat the sealed composition with an adhesive or solvent in order to secure the shape of the film(s) (12).

The properties of the invention will now be further described by way of example.

In this example of the present invention a 28 μm thickness PVOH film was flow-wrapped and heat shrunk onto a compressed particulate dishwashing tablet comprising surfactants, builders, enzymes and auxiliary agents; all typical ADW raw materials. The tablet was compressed with a compression force of 230 kg/cm² in a standard rotary tablet press.

The resulting tablet, naked and wrapped, was assessed for hardness, friability and dissolution time in comparison with a corresponding heavily compressed naked tablet (compressive force 700 kg/cm²).

The results are set out in Table 1 below.

The Hardness testing used a ERWEKA tablet hardness tester THB 30. Standard shaped cuboid 20 g tablets, of size 37 mm by 27 mm by 14 mm were tested to destruction across their width, using an ERWEKA tablet hardness tester THB30. Using this tester the tablet were set on a generally L-shaped support, against the upwardly projecting limb thereof. A circular piston of 8 mm diameter was advanced at a rate of 30 mm per minute and pressed onto the central region of the respective side wall (i.e. one of the sides of size 37 mm by 14 mm), until the tablet was broken.

TABLE 1

| | | | | | Tab | |
|---|---|---|---|---|---|---|
| | | | | Tab weight | weight | |
| | | | | before | after | |
| | | | Dissolution | Friability | Friability | Friability |
| | | Hardness | Time | test | test | in % |
| Tablets | | in N | in Min | in g | in g | in % |
| Unwrapped | | | | | | |
| Hard | | 250 | 10.75 | 21.08 | 19.93 | 5.46 |
| (comparison) | | 244 | 12.00 | 21.17 | 19.77 | 6.61 |
| | Average | 247 | 11.38 | 21.13 | 19.85 | 6.04 |
| Soft | | 136 | 3.00 | 21.12 | 4.87 | 76.94 |
| (comparison) | | 133 | 3.25 | 20.89 | 5.76 | 72.43 |
| | Average | 134.5 | 3.13 | 21.01 | 5.32 | 74.69 |
| Wrapped | | | | | | |
| Hard | | 235 | 10.92 | 21.43 | 21.39 | 0.19 |
| (invention) | | 248 | 12.00 | 21.48 | 21.47 | 0.05 |
| | Average | 241.5 | 11.46 | 21.46 | 21.43 | 0.12 |
| Soft | | 145 | 2.83 | 21.27 | 21.26 | 0.05 |
| (invention) | | 135 | 3.00 | 21.31 | 21.30 | 0.05 |
| | Average | 140 | 2.92 | 21.29 | 21.28 | 0.05 |

The Disintegration testing used a Disintegration-Tester ERWEKA 2T 54, operated at 68 strokes per minute. A one-litre glass beaker was used, containing 800 ml tap water at 40° C. The beaker was placed in a water bath to maintain its temperature. Three tablets were placed in a 3-segment basket. The basket was put in the water, the tester was switched on, giving rise to agitation, and a stopwatch started. The time was noted when the basket was empty.

Friability was measured using a Vankel Friabilator machine, model No. 45-2100 and an analytic balance, accurate to 0.01 g. A tablet was placed in the friabilator drum, set for 30 cycles. At each stop point the tablet was reweighed. Percentage loss is calculated as

$$\frac{Initial weight - Final weight}{Initial weight} \times 100$$

It can be seen that the unwrapped tablets compressed with low compressive force have good dissolution properties but modest mechanical properties. They are of low hardness and are highly friable; they readily release particulates and have a tendency to crumble easily even under low applied stresses, for example in handling. These deficiencies are much improved by the heat-shrunk wrapping; whilst the excellent dissolution properties are unaffected.

1. A process for the preparation of a package containing a compacted particulate composition sealed in at least one film, the process comprising the step of:
application of one or more pressing means on at least one protruding seam of the sealed film such that said at least one seam is rendered substantially congruous with a surface of the compacted particulate composition.

2. A process according to claim 1, wherein the at least one protruding seam is rendered congruous with one or more surfaces of the sealed composition to which it is adjacent.

3. A process according to claim 1, wherein the at least one protruding seam is rendered congruous with one or more predetermined surfaces of the sealed composition by selecting the orientation of the sealed composition when it meets the one or more pressing means.

4. A process according to claim 1, wherein the pressing means are provided in the faun of a pair of pressing means.

5. A process according to claim 4, wherein the pair of pressing means are orientated opposite each other and spaced apart at a distance equal to or less than the width of the sealed composition.

6. A process according to claim 4, wherein the pair of pressing means are spaced apart, at a distance equal to or less than the width of the sealed composition, to be contactable with opposite sides of a sealed composition, wherein said pair of pressing means have a staggered location with respect to each other.

7. A process according to claim 1, wherein the pressing means are a pair of rollers.

8. A process according to claim 1, wherein the pressing means have one or more resiliently deformable surfaces surface.

9. A process according to claim 1, wherein the pressing means are resiliently movable in a substantially perpendicular direction relative to the direction of travel of the sealed composition.

10. A process according to claim 1, wherein the pressing means are provided with the ability to further treat the at least one film.

11. A process according to claim 1, wherein the pressing means are provided with propulsion means adapted to propel the sealed composition through the pressing means.

12. A process according to claim 11, wherein said propulsion means are adapted to propel the sealed composition through the pressing means at a velocity equal to or greater than the velocity at which the sealed composition arrives at the pressing means.

13. A process according to claim 1, wherein the processing of package is operated using linear speeds of between >5 meters/minute to 150 meters/minute.

14. A process according to claim 7, wherein the rollers are configured to operate at rotational speeds between 5-500 rpm.

15. A process according to claim 1, wherein the at least one film is a heat-shrink film.

16. A process according to claim 1, wherein downstream of the pressing means there is further provided a freezing means.

17. A process for the preparation of a package containing a compacted particulate composition, comprising the steps of:
wrapping a compacted particulate composition with at least one film;
sealing the at least one film around said compacted particulate composition; and
subsequently applying one or more pressing means on at least one protruding seam of the sealed film such that said at least one seam is rendered substantially congruous with a surface of the compacted particulate composition.

18. A ware-washing, fabric washing or surface-care package comprising a compacted particulate composition produced according to claim 1, wherein the package has a heat-shrunk film.

19. A ware-washing, fabric washing or surface-care package comprising a compacted particulate composition produced according to claim wherein the package has a heat-shrunk film.
